(19) United States
(12) Patent Application Publication
(10) Pub. No.: US 2016/0036327 A1
(43) Pub. Date: Feb. 4, 2016

(54) BUCK CONVERTER USING VARIABLE PULSE

(71) Applicant: Samsung Electronics Co., Ltd., Suwon-si (KR)

(72) Inventors: Hyun-Seok Nam, Suwon-si (KR); Dong-Jin Keum, Suwon-si (KR); Yus Ko, Yongin-si (KR)

(21) Appl. No.: 14/615,991

(22) Filed: Feb. 6, 2015

(30) Foreign Application Priority Data
Aug. 4, 2014 (KR) 10-2014-0099803

(51) Int. Cl. H02M 3/158

(52) U.S. Cl. CPC H02M 3/158

(57) ABSTRACT

A buck converter using a variable pulse includes a switching unit configured to convert a supply voltage supplied from an external device into an internal voltage, and a pulse controller configured to variably control a driving time of the switching unit according to a result obtained by detecting a difference between the supply voltage and an output voltage which is the internal voltage.

### CROSS-REFERENCE TO RELATED APPLICATION

This application claims priority under 35 U.S.C. §119 to Korean Patent Application No. 10-2014-0099803 filed on Aug. 4, 2014, the entire contents of which are incorporated herein by reference in their entirety.

### BACKGROUND

1. Technical Field

Example embodiments of the present disclosure relate to a buck converter, and particularly, to a buck converter using a variable pulse.

2. Description of Related Art

Generally, a “direct current to direct current” (DC-to-DC) converter for converting an external power source into an internal power source and for providing the internal power source is installed in mobile devices such as a mobile communication terminal, and a personal digital assistant (PDA). For example, the DC-to-DC converter may be a buck converter.

It is very important to manage a battery and the power source in the mobile devices mentioned above. Mobile devices, most of the time, are maintained in a standby mode, and it is important to reduce power consumption in the standby mode since the power is continuously consumed, even in the standby mode.

### SUMMARY

Relatively high power efficiency can be achieved and an operating time of the mobile device by a user can be increased by reducing the power consumption of the buck converter during operation in the standby mode.

Example embodiments of the present disclosure relate to a buck converter which has a simple design and construction, and which can stably operate.

The embodiments of the present disclosure are not limited to the above disclosure; and other embodiments may become apparent to those of ordinary skill in the art based on the following description.

In accordance with an aspect of the present disclosure, a buck converter may include a switching unit configured to convert a supply voltage supplied from an external device into an internal voltage, and a pulse controller configured to variably control a driving time of the switching unit according to a result obtained by detecting a difference between the supply voltage and an output voltage which is the internal voltage.

In an example embodiment, the pulse controller may control to decrease the driving time of the switching unit when the difference between the supply voltage and the output voltage becomes larger, and to increase the driving time of the switching unit when the difference between the supply voltage and the output voltage becomes smaller.

In another example embodiment, the pulse controller may include a current generator configured to detect the difference between the supply voltage and the output voltage and to generate current, a ramp voltage generator configured to generate a ramp voltage having a predetermined gradient using the current from the current generator, and a voltage comparator configured to determine whether the ramp voltage is greater than a predetermined voltage and to provide a variable pulse signal.

In still another example embodiment, the current generator may generate the current in proportion to the difference between the supply voltage and the output voltage.

In yet another example embodiment, when the difference between the supply voltage and the output voltage is great, the voltage comparator may provide the variable pulse signal having a relatively shorter high duration than when the difference between the supply voltage and the output voltage is small.

In accordance with another aspect of the present disclosure, a buck converter may include a switching unit including a pull-up device and a pull-down device, a ripple voltage generator controlled by the switching unit and configured to generate an output voltage of a ripple form which repeatedly increases and decreases along a predetermined gradient by an inductor and a capacitor, a comparator configured to compare the output voltage and a reference voltage, a pulse controller configured to receive a result of the comparator and to generate a variable pulse signal in which a pulse period is varied according to a difference between the supply voltage and the output voltage, and a pulse selector configured to select any one of signals that are output from the comparator and the pulse controller and to control in order to provide the selected one to the switching unit.

In an example embodiment, the pulse controller may control a turn-on time of the pull-up device of the switching unit using the variable pulse signal according to the difference between the supply voltage and the output voltage.

In another example embodiment, the pulse controller may include a current generator configured to detect the difference between the supply voltage and the output voltage and to generate current, a ramp voltage generator configured to generate a ramp voltage having a predetermined gradient using the current from the current generator, and a voltage comparator configured to determine whether the ramp voltage is greater than a predetermined voltage and to provide the variable pulse signal.

In still another example embodiment, the current generator may generate the current in proportion to the difference between the supply voltage and the output voltage.

In yet another example embodiment, the ramp voltage generator may include a capacitor, and a plurality of transistors coupled as a current mirror type. When the current flows through the plurality of transistors, the ramp voltage generator may generate the ramp voltage having the predetermined gradient using a voltage that is charged and discharged in the capacitor.

In yet another example embodiment, when the difference between the supply voltage and the output voltage is great, the voltage comparator may provide the variable pulse signal having a relatively shorter high duration than when the difference between the supply voltage and the output voltage is small.

In yet another example embodiment, the switching unit may include the pull-up device and the pull-down device which are coupled as an inverter type.

In yet another example embodiment, when the pull-up device is turned on in response to an output signal of the switching unit, the ripple voltage generator may generate the output voltage increasing along the predetermined gradient while increasing current flowing through the inductor. When the pull-down device is turned on, the ripple voltage generator may generate the output voltage decreasing along the predetermined gradient while decreasing the current flowing through the inductor.

In yet another example embodiment, the comparator may output a high level when the output voltage is greater than a reference voltage. The comparator may output a low level when the output voltage is smaller than a reference voltage.

In yet another example embodiment, the comparator may include a hysteresis comparator.

In accordance with still another aspect of the present disclosure, a buck converter for converting a supply voltage from an external device into an output voltage which is an internal voltage may include a pulse controller configured to variably control a time for providing the supply voltage in proportion to a difference between the supply voltage and the output voltage.

In an example embodiment, the buck converter may further include a switching unit. The switching unit may include a pull-up device and a pull-down device. While the pull-up device is turned on, The switching unit may provide the supply voltage.

In another example embodiment, the pulse controller may generate a variable pulse signal by detecting the difference between the supply voltage and the output voltage.

In still another example embodiment, when the difference between the supply voltage and the output voltage is great, the pulse controller may decrease a turn-on time of the pull-up device by providing the variable pulse signal having a relatively shorter high duration than when the difference between the supply voltage and the output voltage is small.

In yet another embodiment, when the difference between the supply voltage and the output voltage is small, the pulse controller may increase a turn-on time of the pull-up device by providing the variable pulse signal having a relatively longer high duration than when the difference between the supply voltage and the output voltage is great.

### BRIEF DESCRIPTION OF THE DRAWINGS

The foregoing and other features and advantages of the present disclosure will be apparent from the more particular description of example embodiments of the present disclosure, as illustrated in the accompanying drawings in which like reference characters refer to the same parts throughout the different views. The drawings are not necessarily to scale, emphasis instead being placed upon illustrating the principles of the present disclosure. In the drawings:

FIG. 1 is a circuit diagram illustrating a conventional buck converter;

FIGS. 2A and 2B are graphs illustrating a characteristic of an output voltage according to a time, and a characteristic of inductor current according to a time in a standby mode, respectively;

FIG. 3 is a circuit diagram illustrating a buck converter according to an embodiment of the present disclosure;

FIG. 4 is a circuit diagram illustrating a pulse controller shown in FIG. 3;

FIG. 5 is a timing diagram illustrating a relationship between complementary clock signals and an output signal of a comparator;

FIG. 6A is a timing diagram illustrating a relationship of signals according to time;

FIG. 6B is a timing diagram illustrating current flowing an inductor according to time;

FIGS. 7A and 7B are graphs illustrating a characteristic of an output voltage according to time, and a characteristic of inductor current according to a time in a standby mode, respectively, according to an example embodiment of the present disclosure;

FIG. 8A is a block diagram illustrating a memory system to which a buck converter is applied according to an example embodiment of the present disclosure;

FIG. 8B is a block diagram illustrating a memory system to which a buck converter is applied according to another example embodiment of the present disclosure; and

FIG. 8C is a simplified block diagram illustrating a mobile device to which a buck converter is applied according to still another example embodiment of the present disclosure.

### DETAILED DESCRIPTION OF EMBODIMENTS

Various embodiments will now be described more fully with reference to the accompanying drawings in which some embodiments are shown. These inventive concepts may, however, be embodied in different forms and should not be construed as limited to the embodiments set forth herein. Rather, these embodiments are provided so that this disclosure is thorough and complete and fully conveys the inventive concepts to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of the present disclosure will be described below with reference to accompanying drawings.

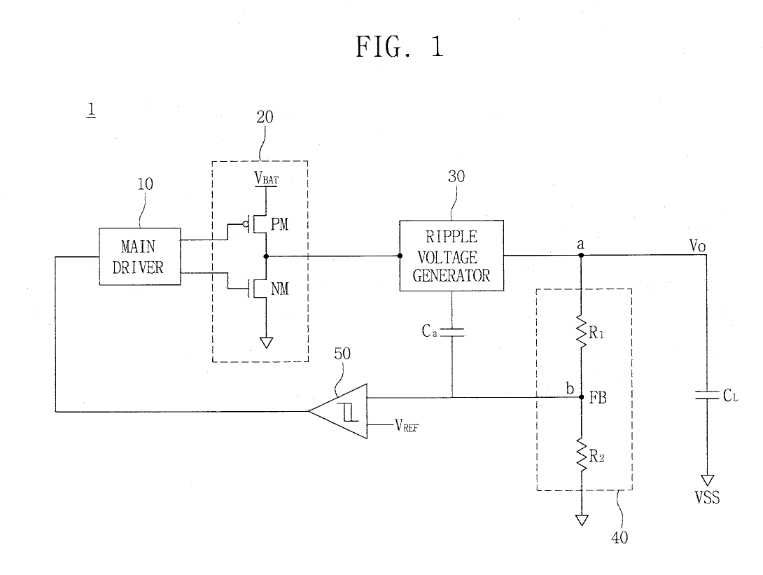

FIG. 1 is a circuit diagram illustrating a conventional buck converter.

A direct current to direct current (DC-to-DC) converter having a minimized resistance component may be needed for a mobile device. When using a voltage drop method by a resistor, power consumption may be necessarily increased. Accordingly, a buck converter using an inductor which can minimize the power consumption and easily obtain a voltage of a target level may be largely used as the DC-to-DC converter.

The buck converter may be one of converters having various manners, and may be a converter including a hysteresis comparator for comparing in a hysteresis manner.

Referring to FIG. 1, the buck converter 1 may include a main driver 10, a switching unit 20, a ripple voltage generator 30, a resistor unit 40, and a comparator 50.

The buck converter 1 may provide a constant output voltage resulting from a comparison of a ripple voltage generated in the ripple voltage generator 30 and a preset reference voltage.

The main driver 10 may be a driver having large drivability for controlling the switching unit 20.

The switching unit 20 may include a PMOS transistor PM and an NMOS transistor NM which are coupled as an inverter type.

The ripple voltage generator 30 may include an inductor (not shown), and may generate the ripple voltage having a constant gradient.

The resistor unit 40 may include a first resistor R₁ and a second resistor R₂. The first resistor R₁ and the second resistor R₂ may be commonly coupled to a node b interposed therebetween. Here, the first resistor R₁ and the second resistor R₂ may substantially have the same resistance. Accordingly, a voltage of the node b, that is, a feedback voltage FB, may be ½ of a voltage of a node a, that is, an output voltage Vₒ.

The comparator 50 may compare a feedback voltage from the node b and a reference voltage V_{REF}. As described above, the comparator 50 may include a hysteresis comparator.

Meanwhile, a capacitor Cₐ may be charged by the ripple voltage generated from the ripple voltage generator 30, and a capacitor C_{L} may represent an output load.

Referring to FIG. 1, in the conventional buck converter 1, a battery voltage V_{BAT} may be provided to the output voltage Vₒ while the PMOS transistor PM is turned on. At this time, inductor current of the ripple voltage generator 30 may be increased along a predetermined gradient. When the PMOS transistor PM is turned off, a power source is supplied using a ground voltage VSS since the NMOS transistor is turned on. At this time, the inductor current of the ripple voltage generator 30 may be decreased along the predetermined gradient.

That is, when the voltage of the node b is greater than the reference voltage V_{REF}, a signal of a “high” level may be output from the comparator 50, and thus, the NMOS transistor NM may be turned on. While the NMOS transistor NM is turned on, the inductor current of the ripple voltage generator 30 may be decreased along a predetermined gradient, and the voltage of the node a may be decreased. When the voltage of the node b is smaller than the reference voltage V_{REF} while being gradually decreased, a signal of a “low” level may be output from the comparator 50, and the PMOS transistor PM may be turned on. The ripple voltage may be generated from the inductor current which is either decreased or increased along the predetermined gradient through a feedback loop, and the output voltage Vₒ having a desired target level may be generated using the ripple voltage.

That is, when the voltage of the node b is greater than the reference voltage V_{REF}, the NMOS transistor NM may be turned on by detecting the output voltage Vₒ greater than the target voltage, and thus, the voltage of the node b may be decreased. On the other hand, when the voltage of the node b is smaller than the reference voltage V_{REF}, the PMOS transistor PM may be turned on by detecting the output voltage Vₒ smaller than the target voltage, and thus, the voltage of the node b may be increased.

However, when entering into a standby mode, a small amount of current may be used in a load coupled to an output unit, but the input voltage may vary according to an external environment. At this time, since the comparator 50 detects a small voltage change at a high speed and frequently drives the switching unit 20, excessive switching current may be generated consequentially.

The above result is from a unique operation of the ripple voltage generator 30, and the buck converter 1 may be configured to be influenced by sizes of the battery voltage V_{BAT} which is a supply voltage, an output voltage Vₒ, an inductor, a capacitor, etc. Therefore, during one period when the PMOS transistor PM and the NMOS transistor NM are turned on, if a power source provided to an output node through the inductor is small, the ripple voltage may be continuously generated by an unstable operation of the comparator 50 since the comparator 50 is operated before the capacitor is sufficiently charged. Accordingly, excessive multi-switching may be generated and a switching current loss may be generated, even in the standby mode. In other words, the conventional buck converter 1 may be difficult to supply a constant power source to a system according to the change of the supply voltage and the output voltage.

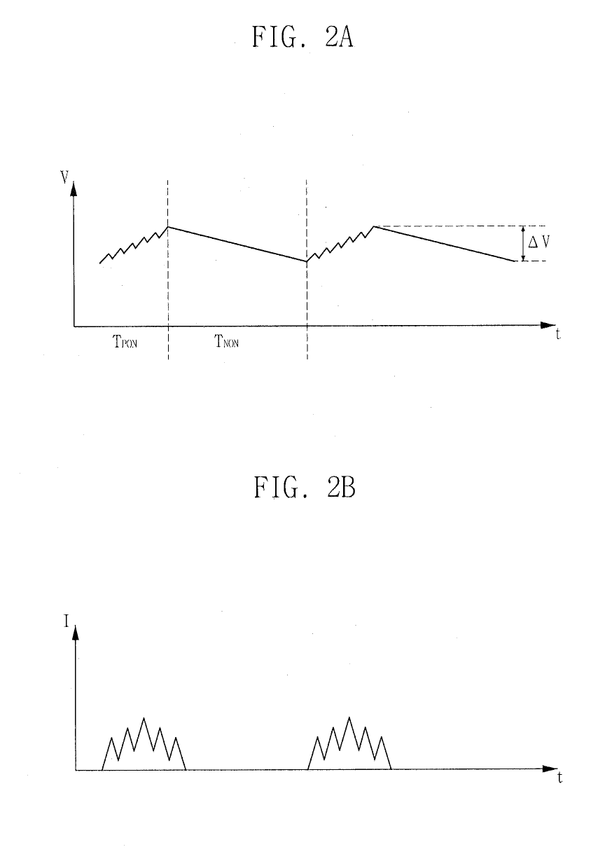

FIGS. 2A and 2B are graphs illustrating a characteristic of an output voltage Vₒ according to time, and a characteristic of inductor current I according to time in a standby mode, respectively.

Referring to FIG. 2A, the X-axis represents time, and the Y-axis represents a voltage.

Referring to FIG. 2A, in the standby mode, the output voltage Vₒ may be unstable while the PMOS transistor PM is turned on TPON. V represents an amplitude of the ripple voltage.

Referring to FIG. 2B, the X-axis represents time, and the Y-axis represents current.

Referring to FIG. 2B, in the standby mode, the inductor current or the ripple current may considerably and excessively perform the multi-switching, and may be generated in a large amount.

As described above, a buck converter using a general ripple injection mode may compare by detecting the small voltage change at a high speed in the standby mode, and thus, multi-switching may frequently occur. Accordingly, power consumption may be increased due to the excessive multi-switching of the switching unit 20. The above result is a disadvantage on the power management and the battery efficiency of the mobile device, and thus, the operating time of the mobile device by the user may be reduced.

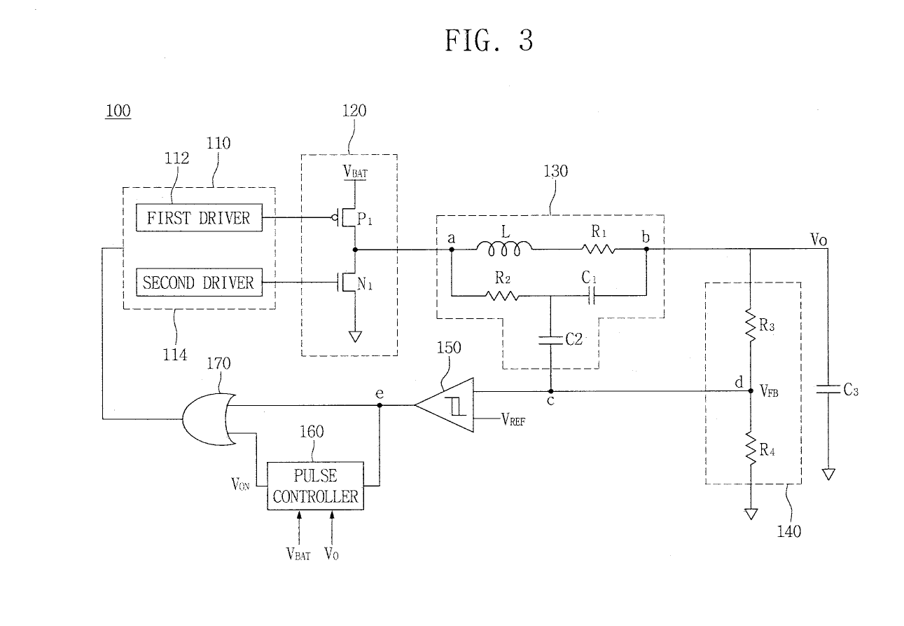

FIG. 3 is a circuit diagram illustrating a buck converter 100 according to an embodiment of the present disclosure.

Here, a hysteretic buck converter using a ripple injection method according to the embodiment of the present disclosure among various buck converters will be described. The buck converter may be a power circuit which converts a high DC voltage into a DC voltage smaller than the high DC voltage. The buck converter using an inductor having a relatively smaller power consumption than a resistor may provide a high energy efficiency. Particularly, the hysteretic buck converter which controls a pull-up and pull-down switch using a hysteresis comparator may use a reference voltage V_{REF} having a specific bandwidth. Accordingly, the hysteretic buck converter may have advantages on a high-speed transient response and stability.

Referring to FIG. 3, the buck converter 100 may include a main driver 110, a switching unit 120, a ripple voltage generator 130, a resistor unit 140, a comparator 150, a pulse controller 160, and a pulse selector 170.

First, the main driver 110 may include a first driver 112 and a second driver 114. The main driver 110 may improve the drivability of the switching unit 120 by controlling a driving of the switching unit 120.

The first driver 112 may be a driver with a large size in order to control a PMOS transistor P₁ of the switching unit 120. The second driver 114 may also be a driver with a large size in order to control an NMOS transistor N₁ of the switching unit 120.

The switching unit 120 may be controlled by the main driver 110, and may provide a voltage received from the pulse selector 170 to an output node during a pulse ON time.

The switching unit 120 may include the PMOS transistor P₁ and the NMOS transistor N₁ which are coupled as an inverter type.

The PMOS transistor P₁ may be controlled by the first driver 112, and may provide the battery voltage V_{BAT} to the output node a. The NMOS transistor N₁ may be controlled by the second driver 114, and may provide a ground voltage to the output node a. The PMOS transistor P₁ may be a pull-up switch and the NMOS transistor N₁ may be a pull-down switch.

The ripple voltage generator 130 may include an inductor L, first and second resistors R₁ and R₂, and first and second capacitors C₁ and C₂.

Here, the inductor L and the second capacitor C₂ may configure an LC filter, that is, a low pass filter.

The first resistor R₁ may be an internal resistor of the inductor L as a modeling, which means a resistance generated when current flows through the inductor L.

The second resistor R₂ and the first capacitor C₁ may detect a voltage of both ends of the inductor L, and may be related to upper and lower limit levels of the current flowing through the inductor L.

The second capacitor C₂ may charge a voltage generated by the inductor L, the first and second resistors R₁ and R₂, and the first capacitor C₁.

The ripple voltage generator 130 may be influenced by the output voltage of the switching unit 120. The ripple voltage generator 130 may receive the battery voltage V_{BAT} when the PMOS transistor P₁ is turned on, and the current flowing through the inductor L is increased. Thus, a voltage of the ripple voltage generator 130 may be increased and then a voltage increasing along the predetermined gradient may occur.

On the other hand, the ripple voltage generator 130 may receive the ground voltage when the NMOS transistor N₁ is turned on, and forward current flowing through the inductor L is decreased. Thus, a voltage of the ripple voltage generator 130 may be decreased and then a voltage decreasing along the predetermined gradient may occur. Accordingly, the ripple voltage generator 130 may generate the ripple voltage in a triangular wave form.

The resistor unit 140 may include third and fourth resistors R₃ and R₄.

The resistor unit 140 may include the third and fourth resistors R₃ and R₄ which are commonly coupled to a node d interposed therebetween. The third and fourth resistors R₃ and R₄ may substantially have the same resistance, and may provide to the comparator 150 a voltage generated by dividing the output voltage Vₒ into two.

The comparator 150 may compare by receiving the reference voltage V_{REF} and the feedback voltage V_{FB}.

The feedback voltage V_{FB} may be a voltage of the node d, and may be a voltage which is substantially related to the output voltage Vₒ. Accordingly, the comparator 150 may compare whether the output voltage Vₒ, that is, the target voltage is greater or smaller than a constant level (the reference voltage), and may provide a result of the comparison.

The pulse controller 160 may be controlled by the battery voltage V_{BAT}, the output voltage Vₒ and the result of the comparison, may generate a pulse signal which is adaptively varied in proportion to a difference between the battery voltage V_{BAT} and the output voltage Vₒ, and may provide the pulse as a control voltage signal V_{ON}. The pulse controller 160 will be described below with reference to the subsequent drawings.

The pulse selector 170 may selectively output a signal with a greater pulse width among the signal output from the comparator 150 and the signal output from the pulse controller 160.

That is, since the pulse selector 170 provides the pulse signal with equal to or greater than a predetermined pulse width to the main driver 110, the buck converter 100 according to the embodiment of the present disclosure may prevent from generating large current even when the small voltage change is generated in the standby mode.

Referring to FIG. 3 again, an operation of the buck converter 100 according to the embodiment of the present disclosure will be described in detail.

While the PMOS transistor P₁ is turned on, a power source is supplied by the battery voltage V_{BAT} which is a supply voltage. At this time, current may be increased along a predetermined gradient by the inductor L of the ripple voltage generator 130. The voltage may be transferred to the node d through the node b. The voltage of the node d may be a voltage generated, by dividing the voltage of the node b into two with the resistors R₃ and R₄. The divided voltage may be provided to the comparator 150, and may be compared with the reference voltage V_{REF} by the comparator 150. The comparator 150 may output a signal of a “high” level when the voltage of the node c is greater than the reference voltage V_{REF}. On the other hand, the comparator 150 may output a signal of a “low” level when the voltage of the node c is smaller than the reference voltage V_{REF}. A predetermined pulse signal having a period of the “high” level may be generated according to the result of the comparison.

Meanwhile, the pulse controller 160 may receive a feedback voltage from a node e, the battery voltage V_{BAT} and the output voltage Vₒ, and may output the pulse signal (apart from the output signal of the comparator 150) having a predetermined period of the “high” level.

Generally, in a normal mode, the signal output from the comparator 150 may be output as a pulse signal having a predetermined activation period. However, when being switched to the standby mode, since the comparator 150 continuously outputs the result of the comparison due to a structure of the buck converter 100 in which the ripple voltage is finely generated even in a small signal change, a plurality of small ripples such as a noise may be included in order to reach the target level while the switching unit 120 is frequently driven. Particularly, in the standby mode, since the comparator 150 outputs the result of the comparison using a small voltage before being sufficiently charged in the capacitor C2, the comparator 150 may output a very short pulse signal.

However, according to the example embodiment of the present disclosure, the comparator 150 may output the variable pulse signal V_{ON} from the pulse controller 160, and may provide a stable pulse signal even in the standby mode by controlling the pulse selector 170 such that the pulse selector 170 can select the variable pulse signal V_{ON}.

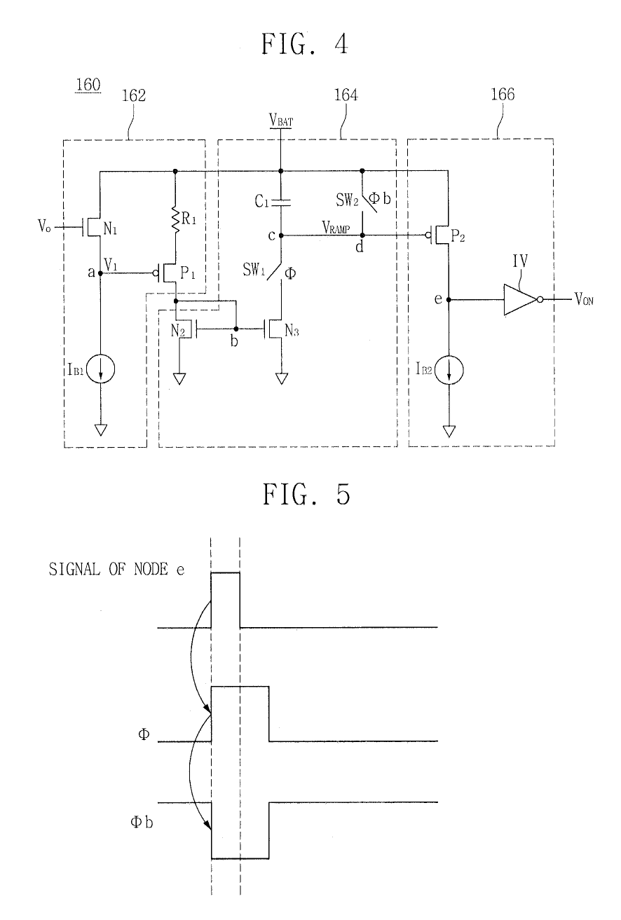

The pulse controller 160 will be described in detail with reference to FIG. 4.

The pulse selector 170 may selectively provide to the main driver 110 a signal of the node e and the variable pulse signal V_{ON} from the pulse controller 160.

FIG. 4 is a circuit diagram illustrating the pulse controller shown in FIG. 3.

Referring to FIG. 4, the pulse controller 160 may include a current generator 162, a ramp voltage generator 164, and a voltage comparator 166.

The pulse controller 160 may generate current according to the changes of the output voltage Vₒ and the battery voltage V_{BAT} which is the supply voltage, and may provide a pulse signal having a predetermined duty ratio using the current.

First, the current generator 162 may receive the output voltage Vₒ, and may generate current in proportion to a difference between the battery voltage V_{BAT} and the output voltage Vₒ.

The current generator 162 may include a first constant current source I_{B1}, a first NMOS transistor N₁, and a second NMOS transistor N₂.

The first NMOS transistor N₁ and the first PMOS transistor P₁ may be configured as a source follower type. The output voltage Vₒ may be supplied to a gate of the first NMOS transistor N₁, the battery voltage V_{BAT} may be supplied to a drain of the first NMOS transistor N₁, and a source of the first NMOS transistor N₁ may be coupled to a node a. A gate of the first PMOS transistor P₁ may be coupled to the node a, the battery voltage V_{BAT} may be supplied to a source of the first PMOS transistor P₁, and a drain of the first PMOS transistor P₁ may be coupled to a node b. Further, the source of the first NMOS transistor N₁ may be coupled to the constant current source I_{B1}. The first resistor R₁ may be further coupled between the source of the first PMOS transistor P₁ and the battery voltage V_{BAT}.

The ramp voltage generator 164 may include second and third NMOS transistors N₂ and N₃, a first capacitor C₁, a first switch SW₁, and a second switch SW₂.

The second and third NMOS transistors N₂ and N₃ may be commonly coupled to the node b, and may be configured as a current mirror type. A drain of the third NMOS transistor N₃ may be coupled to the first switch SW₁. The first capacitor C₁ may be coupled between the first switch SW₁ and the battery voltage V_{BAT}. Meanwhile, a node c which is one end of the first switch SW₁ may be coupled to a node d which is one end of the second switch SW₂. The first and second switches SW₁ and SW₂ may have a shunt connection.

The voltage comparator 166 may include a second PMOS transistor P₂, an inverter IV, and a second constant current source I_{B2}.

A gate of the second PMOS transistor P₂ may be coupled to the node d, a source of the second PMOS transistor P₂ may be coupled to the battery voltage V_{BAT}, and a drain of the second PMOS transistor P₂ may be coupled to a node e. The inverter IV may invert a signal of the node e, and may output the inverted signal as the variable pulse signal V_{ON}. The second constant current source I_{B2} may be coupled between the node e and the ground voltage.

A function of each of components will be described in detail and an operation of the pulse controller 160 will be described at the same time.

The first NMOS transistor N₁ may be turned on by receiving the output voltage Vₒ as a feedback. That is, when the first NMOS transistor N₁ is turned on by applying a proper gate voltage, constant current may flow from the drain of the first NMOS transistor N₁ to the first constant current source I_{B1}, and a constant voltage may be generated at the node a. At this time, a voltage of the node a, that is, V₁, may be a voltage obtained by subtracting a threshold voltage of the first NMOS transistor N₁ from the output voltage Vₒ due to physical characteristics in a saturation region of the first NMOS transistor N₁.

V₁=Vₒ−Vₜₕₒ [Equation 1]

Here, V₁ represents the voltage of the node a, Vₒ represents a gate applying voltage, and Vₜₕₒ represents the threshold voltage of the first NMOS transistor N₁.

That is, as shown in Equation 1, the voltage of the node a, that is, V₁, may have a voltage generated by subtracting from the output voltage Vₒ the threshold voltage needed for turning on the first NMOS transistor N₁.

Meanwhile, since the first PMOS transistor P₁ which is turned on in response to the voltage of the node a has the source follower type together with the first NMOS transistor N₁, the first PMOS transistor P₁ may be determined whether to be turned on according to the voltage of the node a, that is, V1.

As is well-known, according to the physical characteristics, a voltage of the source of the first PMOS transistor P₁ may be represented as a voltage generated by adding the input voltage and the threshold voltage of the first PMOS transistor P₁. Accordingly, supposing that the voltage of the source of the first PMOS transistor P₁ is V2, V2 may be represented by the following Equation 2.

V2=V1+Vₜₕₒ [Equation 2]

Here, V2 represents the voltage of the node b, V1 represents the voltage of the node a, and Vₜₕₒ represents the threshold voltage of the first PMOS transistor P₁.

The following Equation 3 may be obtained by substituting Equation 1 in V₁ of Equation 2.

V2=V1+Vₜₕₒ=(Vₒ−Vₜₕₒ)+Vₜₕₒ=Vₒ [Equation 3]

Here, supposing that the threshold voltage of the first NMOS transistor N₁ and the threshold voltage of the first PMOS transistor P₁ have substantially the same value by forming in the same condition, V2 may be the output voltage Vₒ.

Accordingly, current I flowing the first PMOS transistor P₁ via the resistor R₁ may be represented by the following Equation 4.

$$I = \frac{{V}_{BAT} - {V}_{O}}{{R}_{1}} \qquad [ Equation 4 ]$$

Here, R₁ represents a resistance of the first resistor, V_{BAT} represents the supply voltage, and Vₒ represents the output voltage.

That is, the current generator 162 may control to flow current using the output voltage Vₒ as a feedback and the battery voltage V_{BAT} which is the supply voltage. Even when the output voltage Vₒ is constant, the battery voltage V_{BAT} which is the supply voltage may by varied according to an external environment. At this time, according to the embodiment of the present disclosure, when the battery voltage V_{BAT} is increased, the current generator 162 may control the variable pulse signal V_{ON} to have a relatively short pulse ON time. For this, the current generator 162 may flow adaptively variable current according to a difference between the output voltage Vₒ as a feedback and the battery voltage V_{BAT}, and the ramp voltage generator 164 may generate a ramp voltage by mirroring the adaptively variable current.

The second and third NMOS transistors N₂ and N₃ which are coupled as the current mirror type in the ramp voltage generator 164 may be controlled by the voltage of the node b, and thus, the adaptively variable current may be mirrored.

A positive clock signal φ may be applied to the first switch SW₁, and a negative clock signal φb may be applied to the second switch SW₂.

Here, the positive and negative clock signals φ and φb may be complementary clock signals. A circuit for generating the complementary clock signals is not shown. The positive clock signal φ may be generated as a latch signal by detecting a rising edge of the pulse signal generated by the comparator (see 150 of FIG. 3), and the negative clock signal φb having an inverted level of the positive clock signal φ may be generated as the latch signal. For example, a “high duration” of the positive clock signal φ may be determined from the rising edge of the pulse signal generated by the comparator (see 150 of FIG. 3) to a falling edge of the variable pulse signal V_{ON}.

FIG. 5 is a timing diagram illustrating a relationship between complementary clock signals φ and φb and an output signal of a comparator.

Referring to FIG. 5, the positive clock signal φ may be generated by detecting a rising edge of the pulse signal (the signal of the node e) generated by the comparator (see 150 of FIG. 3). The negative clock signal φb may be generated by inverting a phase of the positive clock signal φ.

Continuously, the negative clock signal φb of the second switch SW₂ may be activated. Accordingly, even when the voltage of the node b is applied, the third NMOS transistor N₃ may not be yet turned on. Accordingly, the node d may maintain the battery voltage V_{BAT} which is charged. As time goes on, the voltage of the node d may be decreased along a predetermined gradient by a result obtained by Equation 4. The voltage generated by the first resistor R₁ and the first capacitor C₁ may be output as the voltage of the node d, that is, the ramp voltage V_{RAMP}.

At this time, the ramp voltage V_{RAMP} may be represented by a correlation between current and a capacitance, and may be represented by the following Equation 5.

$$I * t = {C}_{1} * V \\ V = \frac{I}{{C}_{1}} t \qquad [ Equation 5 ]$$

Here, I represents the current, C₁ represents a capacitance, and V represents the ramp voltage.

The following Equation may be obtained by substituting I of Equation 4 in Equation 5.

$$V = \frac{{V}_{BAT} - {V}_{O}}{{R}_{1} * {C}_{1}} t$$

The voltage comparator 166 may determine whether the voltage of the node d, that is, the ramp voltage V_{RAMP}, is greater than the threshold voltage of the second PMOS transistor P₂, and may output a result of the determination. That is, while the voltage of the node d, that is, the ramp voltage V_{RAMP}, is charged to the battery voltage V_{BAT} and is decreased to a predetermined level, since the second PMOS transistor P₂ is turned off, the signal of a “high” level may be output by the inverter IV (V_{ON}=H). After this, when the ramp voltage V_{RAMP} is smaller than the threshold voltage of the second PMOS transistor P₂, since the second PMOS transistor P₂ is turned on, the signal of a “low” level may be output by the inverter IV (V_{ON}=L).

Accordingly, the duty ratio of the variable pulse signal V_{ON} may be defined as follows.

$${T}_{AOT} = \frac{{C}_{1} {R}_{1}}{{V}_{BAT} - {V}_{O}} {V}_{th , p} \qquad [ Equation 6 ]$$

Here, T_{AOT} represents the pulse ON time.

When the battery voltage V_{BAT}, which is the supply voltage, is increased, since the gradient of the ramp voltage V_{RAMP} is increased (see Equation 5) and thus the current is increased, the pulse signal related to the driving of the switching unit (see 120 of FIG. 3) in order to constantly maintain the inductor current may have a short ON time. Accordingly, when the battery voltage V_{BAT} is increased, a peak level of the inductor current may be constantly maintained by controlling to shorten the ON time of the pulse signal. Here, even when the pulse signal has a relatively short ON time, the pulse signal may have a longer high level period than the pulse signal from the comparator 150 in the standby mode. Accordingly, in the standby mode, the pulse selector 170 may select the signal from the pulse controller 160.

On the other hand, when the battery voltage V_{BAT} is decreased, since the gradient of the ramp voltage V_{RAMP} is decreased (see FIG. 5) and thus the current is decreased, the pulse signal related to the driving of the switching unit (see 120 of FIG. 3) in order to constantly maintain the inductor current may have a predetermined long ON time. Accordingly, when the battery voltage V_{BAT} is decreased, a peak level of the inductor current may be constantly maintained by controlling to lengthen the ON time of the pulse signal.

In order to stably operate the buck converter 100 in the standby mode, the frequency and the peak level of the inductor current may be constantly maintained regardless of the change of the battery voltage V_{BAT} and the output voltage Vₒ. Accordingly, the ON time of the switching unit 120 may be variably controlled according to the change of the battery voltage V_{BAT} and the output voltage Vₒ.

According to the embodiment of the present disclosure, the amount of the current may be varied in proportion to the difference between the output voltage Vₒ and the battery voltage V_{BAT}, and the ramp voltage V_{RAMP} having the predetermined gradient may be generated using the current. At this time, the variable pulse signal V_{ON} which is varied may be generated in response to the voltage change of the output voltage Vₒ and the battery voltage V_{BAT}.

The gradient of the ramp voltage V_{RAMP} may be determined by the difference between the output voltage Vₒ and the battery voltage V_{BAT}, and the variable pulse signal V_{ON} having a pulse width corresponding to a reciprocal of the gradient of the ramp voltage V_{RAMP} may be generated. Accordingly, the ON time of the PMOS transistor of the switching unit (see 130 of FIG. 3) may be variably controlled in response to the changes of the output voltage Vₒ and the battery voltage V_{BAT}.

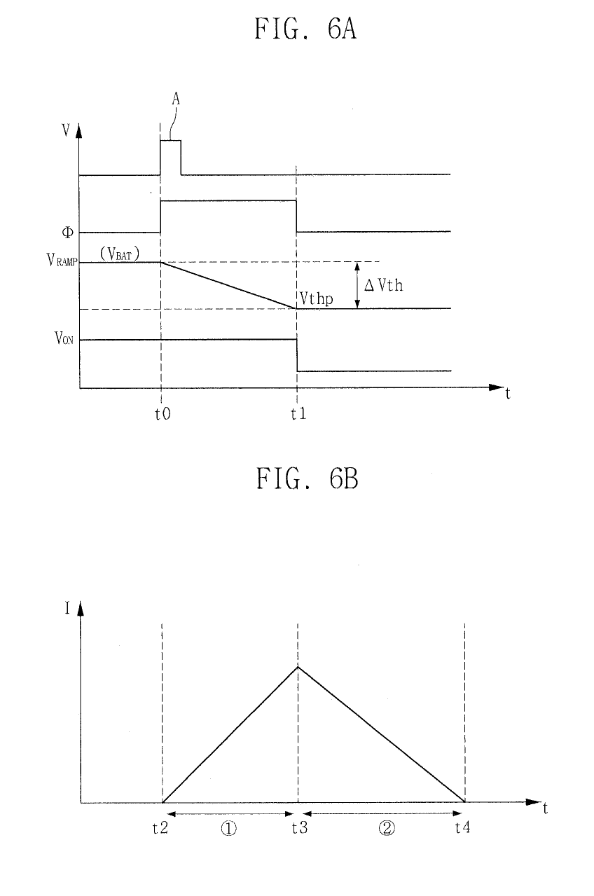

FIGS. 6A and 6B are timing diagrams illustrating operations the circuits shown in FIGS. 3 and 4.

FIG. 6A is a timing diagram illustrating a relationship of signals according to a time t.

A pulse signal A may be output from the comparator 150.

A positive pulse signal φ detected at the rising edge of the pulse signal A may be activated at time t0.

The ramp voltage V_{RAMP} may be charged to a full level (the battery voltage) till time t0, and, as time goes on, the ramp voltage V_{RAMP} may be decreased along a predetermined gradient.

Meanwhile, the variable pulse signal V_{ON} may be maintained at a constant level till time t2, and may be inverted when the ramp voltage V_{RAMP} is smaller than the threshold voltage of the second PMOS transistor P₂.

FIG. 6B is a timing diagram illustrating a current flowing an inductor L according to a time t.

A period \textcircled{1} between times t2 and t3 represents current flowing when the first PMOS transistor P₁ of FIG. 3 is turned on according to the variable pulse signal V_{ON}.

A period □ between times t3 and t4 represents current flowing when the first NMOS transistor N₁ of FIG. 3 is turned on according to the variable pulse signal V_{ON}.

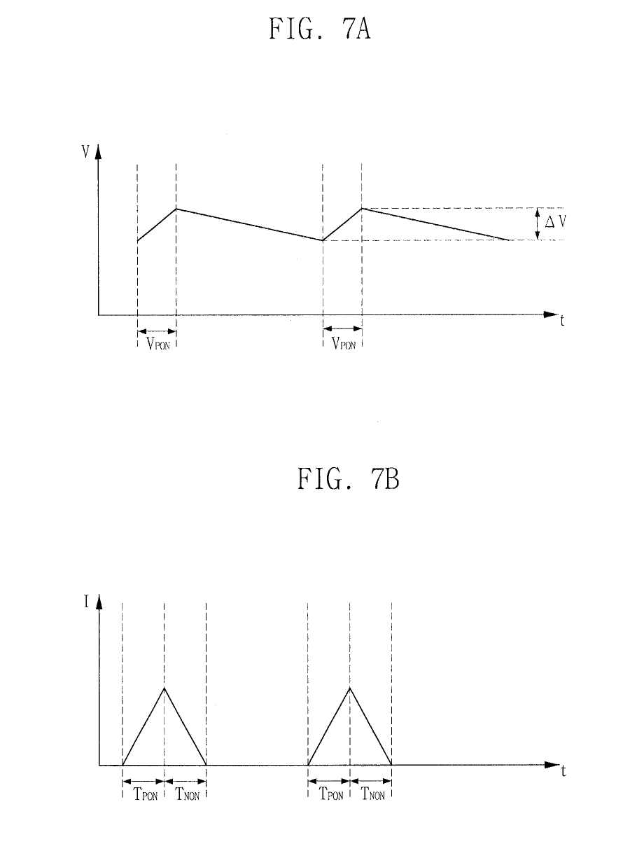

FIGS. 7A and 7B are graphs illustrating a characteristic of an output voltage Vₒ according to time, and a characteristic of inductor current I according to time in a standby mode, respectively, according to an embodiment of the present disclosure.

Referring to FIG. 7A, in the standby mode, the output voltage Vₒ may be constantly generated as the ripple voltage within a voltage range of ΔVₜₕ (a range between the battery voltage V_{BAT} and the threshold voltage Vₜₕₚ of the transistor). This may represent that the output voltage Vₒ is stably output.

Referring to FIG. 7B, the current flowing the inductor may be stably generated with a predetermined period without performing multi-switching.

As shown in FIGS. 7A and 7B, even when entering the standby mode, the peak level of the inductor may be stably maintained by generating the variable pulse signal V_{ON} with a predetermined pulse width, and the generation of a multi-switching pulse signal may be prevented. Accordingly, power consumption generated due to the multi-switching may be prevented.

For such a reason, the ripple of the output voltage Vₒ may be constantly maintained. Therefore, a constant power source may be provided to a load system based on the stable output voltage, and further, the operating time by the user may be increased.

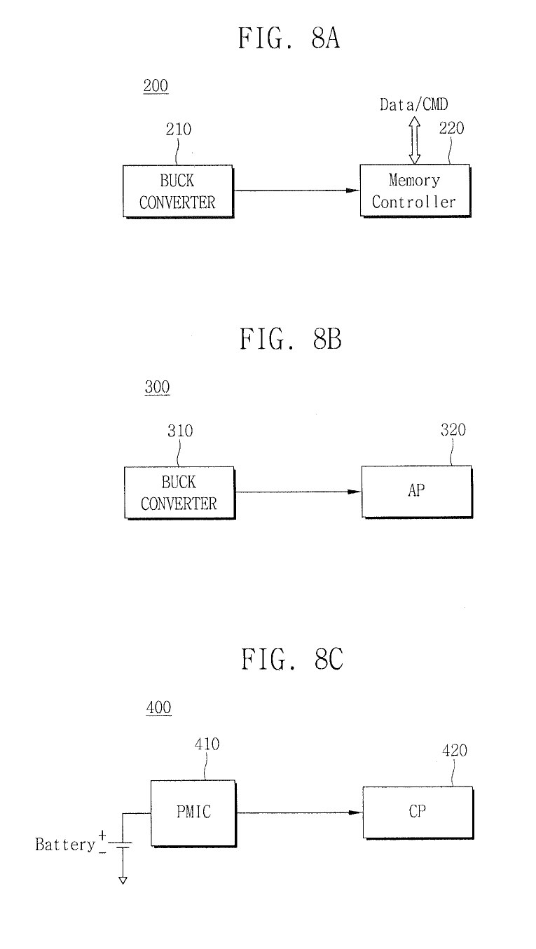

FIG. 8A is a block diagram illustrating a memory system to which a buck converter is applied according to an embodiment of the present disclosure.

Referring to FIG. 8A, the memory system 200 may include a buck converter 210 and a memory controller 220.

The buck converter 210 may control the memory controller 220, may convert a DC voltage provided from the outside into a voltage suitable for the internal memory controller 220, and may provide the converted voltage. The memory controller 220 may transmit and receive a data/command signal Data/CMD to and from external devices.

At this time, the buck converter 210 may be the buck converter according to the embodiment of the present disclosure. Accordingly, the power consumption generated due to the multi-switching may be prevented by applying a construction inputting the feedback voltage to the hysteresis comparator, and particularly, by generating a constant ripple voltage even when the difference between the supply voltage and the output voltage is great.

FIG. 8B is a block diagram illustrating a memory system to which a buck converter is applied according to another embodiment of the present disclosure.

Referring to FIG. 8B, the memory system 300 may include a buck converter 310 and an application processor (AP) 320.

The buck converter 310 may convert a needed power source, and may provide the converted power source to the AP 320. The AP 320 may be various APs, and the AP 320 may be a field-programmable gate array (FPGA) including a central processing unit (CPU) and an input/output (IO) interface.

Meanwhile, the buck converter 310 may be the buck converter according to the embodiment of the present disclosure. Accordingly, the power consumption generated due to the multi-switching may be prevented by applying a construction inputting the feedback voltage to the hysteresis comparator, and particularly, by generating a constant ripple voltage even when the difference between the supply and the output voltage is great.

FIG. 8C is a block diagram illustrating a mobile device 400 to which a buck converter is applied according to still another embodiment of the present disclosure.

Referring to FIG. 8C, the mobile device 400 may include a power management integrated circuit (PMIC) 410 and a communication processor (CP) 420.

The PMIC 410 may manage and convert the power source provided from the battery, and may provide the power source to the CP 420.

Further, the CP 420 may be controlled by the PMIC 410, and may perform a link management and a protocol conversion of data. The CP 420 may be a conventional communication controller.

The PMIC 410 may be the buck converter according to the embodiment of the present disclosure. Accordingly, the PMIC 410 may apply a construction inputting the feedback voltage to the hysteresis comparator, and may prevent the multi-switching even when the supply voltage and the output voltage are changed. Therefore, a stable operation can be performed, and a power efficiency can be increased.

The buck converter according to the embodiment of the present disclosure can be applied in various fields of the mobile power conversion circuit. Further, since the buck converter comparing an error having hysteresis according to the embodiment of the present disclosure has a fast response time and a small size, it is very useful for a high performance, a high efficiency, and a high density integration. Accordingly, the mobile device applying the buck converter according to the embodiment of the present disclosure can effectively manage the power source and increase the operating time by the user.

The present disclosure can apply to the mobile device, and particularly, the buck converter and a memory system including the same.

The buck converter according to the present disclosure can provide a stable output voltage by generating the variable pulse signal corresponding to the current generated in response to the difference between the supply voltage and the output voltage.

The foregoing is illustrative of embodiments and is not to be construed as limiting thereof. Although a few embodiments have been described, those skilled in the art will readily appreciate that many modifications are possible without materially departing from the novel teachings and advantages. Accordingly, all such modifications are intended to be included within the scope of the present disclosure as defined in the claims. In the claims, means-plus-function clauses are intended to cover the structures described herein as performing the recited function, and not only structural equivalents but also equivalent structures.

What is claimed is:

1. A buck converter, comprising:
a switching unit configured to receive a supply voltage from an external device and to convert the supply voltage into an internal voltage;
a driver configured to control the switching unit; and
a pulse controller including:
a current generator configured to detect a difference between the supply voltage and the internal voltage, and to generate current based on the difference between the supply voltage and the internal voltage;
a ramp voltage generator configured to generate a ramp voltage using the current from the current generator; and
a voltage comparator configured to determine whether the ramp voltage is greater than a predetermined voltage, and to output a variable pulse signal,
wherein the pulse controller is configured to variably control a driving time of the switching unit based on the difference between the supply voltage and the internal voltage.

2. The buck converter according to claim 1, wherein the pulse controller is configured to decrease the driving time of the switching unit when the difference between the supply voltage and the internal voltage is greater than a first value, and to increase the driving time of the switching unit when the difference between the supply voltage and the internal voltage is less than a second value.

3. The buck converter according to claim 1, further comprising a comparator configured to compare the internal voltage and a reference voltage.

4. The buck converter according to claim 1, wherein the current generator is configured to generate the current in proportion to the difference between the supply voltage and the internal voltage.

5. The buck converter according to claim 1, wherein, when the difference between the supply voltage and the internal voltage is greater than a predetermined value, the voltage comparator is configured to provide the variable pulse signal having a first high duration, and
when the difference between the supply voltage and the internal voltage is less than the predetermined value, the voltage comparator is configured to provide the variable pulse signal having a second high duration that is greater than the first high duration.

6. A buck converter, comprising:
a switching unit including a pull-up device and a pull-down device;
a voltage generator configured to generate an output voltage which repeatedly increases and decreases, the voltage generator including an inductor and a capacitor;
a comparator configured to compare the output voltage and a reference voltage;
a pulse controller configured to receive a result of comparing the output voltage and the reference voltage, and configured to generate a variable pulse signal based on a difference between the supply voltage and the output voltage, a pulse period of the variable pulse signal being varied; and
a pulse selector configured to select either a signal output from the comparator or the variable pulse signal output from the pulse controller, and configured to provide the selected signal to the switching unit.

7. The buck converter according to claim 6, wherein the pulse controller is configured to control a turn-on time of the pull-up device of the switching unit using the variable pulse signal based on the difference between the supply voltage and the output voltage.

8. The buck converter according to claim 6, wherein the pulse controller comprises:
a current generator configured to detect the difference between the supply voltage and the output voltage, and to generate current based on the difference between the supply voltage and the output voltage;
a ramp voltage generator configured to generate a ramp voltage using the current from the current generator; and
a voltage comparator configured to determine whether the ramp voltage is greater than a predetermined voltage, and to output the variable pulse signal.

9. The buck converter according to claim 8, wherein the current generator is configured to generate the current in proportion to the difference between the supply voltage and the output voltage.

10. The buck converter according to claim 8, wherein the ramp voltage generator comprises a capacitor and a plurality of transistors, and
when the current flows through the plurality of transistors, the ramp voltage generator generates the ramp voltage having a predetermined gradient using a voltage charged and discharged in the capacitor.

11. The buck converter according to claim 8, wherein, when the difference between the supply voltage and the output voltage is greater than a predetermined value, the voltage comparator is configured to provide the variable pulse signal having a first high duration, and
when the difference between the supply voltage and the output voltage is less than the predetermined value, the voltage comparator is configured to provide the variable pulse signal having a second high duration that is greater than the first high duration.

12. The buck converter according to claim 6, wherein the pull-up device and the pull-down device are coupled as an inverter type.

13. The buck converter according to claim 6, wherein, when the pull-up device is turned on in response to an output signal of the switching unit, the voltage generator is configured to generate the output voltage increasing along a predetermined gradient while increasing current flowing through the inductor, and
when the pull-down device is turned on, the voltage generator is configured to generate the output voltage decreasing along the predetermined gradient while decreasing the current flowing through the inductor.

14. The buck converter according to claim 6, wherein the comparator is configured to output the signal with a high level when the output voltage is greater than the reference voltage, and
the comparator is configured to output the signal with a low level when the output voltage is less than the reference voltage.

15. The buck converter according to claim 14, wherein the comparator includes a hysteresis comparator.

16. A portable electronic device comprising:
an application processor; and
a buck converter configured to convert a supply voltage into an internal voltage and to provide the internal voltage to the application processor,
wherein the buck converter comprises:
a switching unit configured to receive the supply voltage and to convert the supply voltage into the internal voltage; and
a pulse controller configured to detect a difference between the supply voltage and the internal voltage and configured to variably control a driving time of the switching unit based on the difference between the supply voltage and the internal voltage.

17. The portable electronic device according to claim 16, wherein the switching unit comprises a pull-up device and a pull-down device, and
the switching unit is configured to provide the supply voltage while the pull-up device is turned on.

18. The portable electronic device according to claim 16, wherein the pulse controller is configured to generates a variable pulse signal based on the difference between the supply voltage and the internal voltage.

19. The portable electronic device according to claim 16, wherein the internal voltage provided to the application processor by the buck converter is constant.

20. The portable electronic device according to claim 16, wherein the pulse controller is configured to variably control a driving time of the switching unit based on the difference between the supply voltage and the internal voltage.
